(19) United States
(12) Patent Application Publication
(10) Pub. No.: US 2023/0135769 A1
(43) Pub. Date: May 4, 2023

(54) NEURAL NETWORKS FOR GENERATING EMOTIVE GESTURES FOR VIRTUAL AGENTS

(71) Applicant: University of Maryland, College Park, College Park, MD (US)

(72) Inventors: Uttaran BHATTACHARYA, College Park, MD (US); Aniket BERA, Greenbelt, MD (US); Dinesh MANOCHA, Bethesda, MD (US); Abhishek BANERJEE, Mountain View, CA (US); Pooja GUHAN, College Park, MD (US); Nicholas REWKOWSKI, Greenbelt, MD (US)

(21) Appl. No.: 17/977,808

(22) Filed: Oct. 31, 2022

Related U.S. Application Data
(60) Provisional application No. 63/263,295, filed on Oct. 29, 2021.

(51) Int. Cl. G06F 3/01; G06N 3/0455

(52) U.S. Cl. CPC G06F 3/017; G06N 3/0455

(57) ABSTRACT

Systems and methods of the present invention for gesture generation include: receiving a sequence of one or more word embeddings, one or more attributes, a gesture generation machine learning model; providing the sequence of one or more word embeddings and the one or more attributes to the gesture generation machine learning model; and providing the second emotive gesture of the virtual agent from the gesture generation machine learning model. The gesture generation machine learning model is configured to: produce, via an encoder, an output based on the one or more word embeddings; generate one or more encoded features based on the output and the one or more attributes; and produce, via a decoder, a emotive gesture based on the one or more encoded features and the preceding emotive gesture. Other aspects, embodiments, and features are also claimed and described.

### CROSS-REFERENCE TO RELATED APPLICATION(S)

This application claims the benefit of U.S. Provisional Patent Application Ser. No. 63/263,295, filed Oct. 29, 2021, the disclosure of which is hereby incorporated by reference in its entirety, including all figures, tables, and drawings.

### STATEMENT REGARDING FEDERALLY SPONSORED RESEARCH

This invention was made with government support under W911NF1910069 and W911NF1910315 awarded by the Department of the Army; Army Research Office (ARO). The government has certain rights in the invention.

### BACKGROUND

Interactions between humans and virtual agents are being used in various applications, including online learning, virtual interviewing and counseling, virtual social interactions, and large-scale virtual worlds. Current game engines and animation engines can generate humanlike movements for virtual agents. However, aligning these movements with a virtual agent's associated speech or text transcript is challenging. As the demand for realistic virtual agents endowed with social and emotional intelligence continues to increase, research and development continue to advance virtual agent technologies.

### SUMMARY

The disclosed technology relates to systems and methods for gesture generation, including: receiving a sequence of one or more word embeddings and one or more attributes; obtaining a gesture generation machine learning model; providing the sequence of one or more word embeddings and the one or more attributes to the gesture generation machine learning model; and providing a second emotive gesture of the virtual agent from the gesture generation machine learning model. The gesture generation machine learning model is configured to: receive, via an encoder, the sequence of the one or more word embeddings; produce, via the encoder, an output based on the one or more word embeddings; generate one or more encoded features based on the output and the one or more attributes; receive, via a decoder, the one or more encoded features and a first emotive gesture of a virtual agent, the first emotive gesture being generated from the decoder at a preceding time step; and produce, via the decoder, the second emotive gesture based on the one or more encoded features and the first emotive gesture.

The disclosed technology also relates to systems and methods for gesture generation training, including: receiving ground-truth gesture; a sequence of one or more word embeddings and one or more attributes; providing the sequence of one or more word embeddings and the one or more attributes to a gesture generation machine learning model; and training the gesture generation machine learning model based on the ground-truth gesture and a second emotive gesture. The gesture generation machine learning model configured to: receive, via an encoder, the sequence of the one or more word embeddings; produce, via the encoder, an output based on the one or more word embeddings; generate one or more encoded features based on the output and the one or more attributes; receive, via a decoder, the one or more encoded features and a first emotive gesture of a virtual agent, the first emotive gesture being generated from the decoder at a preceding time step; and produce, via the decoder, the second emotive gesture based on the one or more encoded features and the first emotive gesture

The above features and advantages of the present invention will be better understood from the following detailed description taken in conjunction with the accompanying drawings.

### BRIEF DESCRIPTION OF THE DRAWINGS

FIG. 1 illustrates an example directed pose graph, in accordance with various aspects of the techniques described in this disclosure.

FIG. 2 illustrates an example machine learning model, in accordance with various aspects of the techniques described in this disclosure.

FIG. 3 illustrates example variance in emotive gestures, in accordance with various aspects of the techniques described in this disclosure.

FIG. 4 illustrates example gesture-based affective features, in accordance with various aspects of the techniques described in this disclosure.

FIG. 5 illustrates end-effector trajectories for existing and example methods, in accordance with various aspects of the techniques described in this disclosure.

FIG. 6 illustrates snapshots of gestures at five time steps from two sequences with sample ground-truth and example methods, in accordance with various aspects of the techniques described in this disclosure.

FIG. 7 illustrates distribution of values from the intended and perceived emotions in the valence, arousal, and dominance dimensions for gestures, in accordance with various aspects of the techniques described in this disclosure.

FIG. 8 illustrates responses on the quality of gestures, in accordance with various aspects of the techniques described in this disclosure.

FIG. 9 illustrates an example system level block diagram for gesture generation, in accordance with various aspects of the techniques described in this disclosure.

FIG. 10 is a flowchart illustrating an example method and technique for virtual agent gesture generation, in accordance with various aspects of the techniques described in this disclosure.

FIG. 11 is a flowchart illustrating an example method and technique for machine learning model training for virtual agent gesture generation, in accordance with various aspects of the techniques described in this disclosure.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. One skilled in the art will recognize that embodiments of the present invention may be practiced without many of these specific details. In other instances, well-known machines, structures, and method steps have not been described in particular detail in order to avoid unnecessarily obscuring embodiments of the present invention. Unless otherwise indicated, like parts and method steps are referred to with like reference numerals.

The present disclosure provides an example neural network-based method to interactively generate emotive gestures (e.g., head gestures, hand gestures, full-body gestures, etc.) for virtual agents aligned with natural language inputs (e.g., text, speech, etc.). The example method generates emotionally expressive gestures (e.g., by utilizing the relevant biomechanical features for body expressions, also known as affective features). The example method can consider the intended task corresponding to the natural language input and the target virtual agents' intended gender and handedness in the generation pipeline. The example neural network-based method can generate the emotive gestures at interactive rates on a commodity GPU. The inventors conducted a web-based user study and observed that around 91% of participants indicated the generated gestures to be at least plausible on a five-point Likert Scale. The emotions perceived by the participants from the gestures are also strongly positively correlated with the corresponding intended emotions, with a minimum Pearson coefficient of 0.77 in the valence dimension.

Transforming Text to Gestures: In some examples, given a natural language text sentence associated with an acting task of narration or conversation, an intended emotion, and attributes of the virtual agent, including gender and handedness, the virtual agent's corresponding gestures (e.g., body gestures) can be generated. In other words, a sequence of relative 3D joint rotations [symbol] underlying the poses of a virtual agent can be generated. Here, the sequence of relative 3D joint rotations can correspond to a sequence of input words [symbol] . In further examples, the sequence of relative 3D joint rotations can be subject to the acting task A and the intended emotion E based on the text, and the gender G and the handedness H of the virtual agent. The sequence of relative 3D joint rotations [symbol] can be expressed as:

$${𝒬}^{⋆} = arg {max}_{S} Prob [ S \vert 𝒲 ; A , E , G , H ] . \qquad Equation 1$$

Representing Text: In some examples, the word at each position in the input sentence [symbol] =[w₁ . . . w_{S} . . . w_{T}_{ₛₑₙ}] with Tₛₑₙbeing the maximum sentence length can be represented using word embeddings w_{S}∈ [symbol] . In some embodiments, the word embeddings can be obtained via a suitable embedding model. In some examples, the word embeddings can be obtained using a GloVe model (e.g., pre-trained on the Common Crawl corpus). However, it should be appreciated that any other suitable embedding model (e.g., Word2Vec, FastText, BERT, etc.) can be used to obtain the word embeddings.

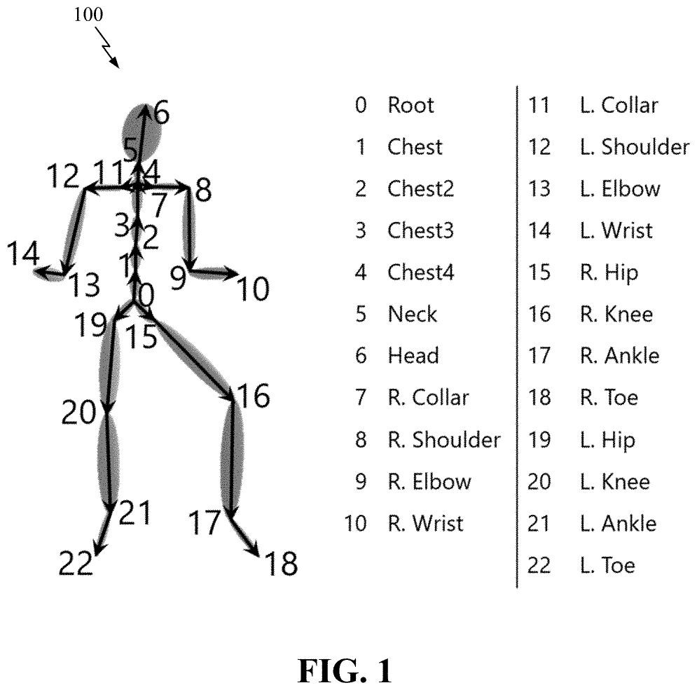

Representing Gestures: In some examples, a gesture can be represented as a sequence of poses or configurations of the 3D body joints. The sequence of poses or configurations can include body expressions as well as postures. In further examples, each pose can be represented with quaternions denoting 3D rotations of each joint relative to its parent in the directed pose graph as shown in FIG. 1. In FIG. 1, the pose graph is a directed tree including multiple joints. For example, a directed tree can include 23 joints, with the root joint 0 as the root node of the tree, and the end-effector joints (head 6, wrists 10, 14, and toes 18, 22) as the leaf nodes of the tree. The directed tree can include other joints (e.g., chest 1-4, neck 5, right collar 7, right shoulder 8, right elbow 9, left collar 11, left shoulder 12, left elbow 13, right hip 15, right knee 16, right ankle 17, left hip 19, left knee 20, left ankle 21). In some examples, the appropriate joints can be manipulated to generate emotive gestures. In further examples, at each time step t in the sequence [symbol] =[q₁ . . . qₜ . . . q_{T}_{_{ges}}] with T_{ges} being the maximum gesture length, the pose can be represented using flattened vectors of unit quaternions qₜ=[. . . q_{j,t}^{T}]^{T}∈ [symbol] . Each set of multiple entries (e.g., 4 entries) in the flattened vector qₜ, represented as q_{j,t} is the rotation on joint j relative to its parent in the directed pose graph, and J is the total number of joints. In some examples, root 0 is a parent joint of chest 1, right hip 15, and/or left hip 19. In further examples, right hip 15 is a parent joint of right ankle 16, which is a parent joint of right toe 18. In some examples, quaternions can be chosen over other representations to represent rotations as quaternions are free of the gimbal lock problem. In further examples, the start and the end of sentences can be demarcated using special start of sequence (SOS) and end of sequence (EOS) vectors or poses. Both of these are idle sitting poses with decorative changes in the positions of the end-effector joints, the root, wrists, and the toes.

Representing the Agent Attributes: In some examples, the agent attributes can be categorized into two types: attributes depending on the input text and attributes depending on the virtual agent.

Attributes Depending on Text: In further examples, the attributes depending on text can include two attributes: the acting task and the intended emotion.

Acting Task: In some examples, the acting task can include two acting tasks: narration and conversation. In narration, the agent can narrate lines from a story to a listener. The gestures, in this case, are generally more exaggerated and theatrical. In conversation, the agent can use body gestures to supplement the words spoken in conversation with another agent or human. The gestures can be subtler and more reserved. An example formulation can represent the acting task as a two-dimensional one-hot vector A∈{0, 1}², to denote either narration or conversation.

Intended Emotion: In some examples, each text sentence can be associated with an intended emotion, given as a categorical emotion term such as joy, anger, sadness, pride, etc. In other examples, the same text sentence can be associated with multiple emotions. In further examples, the national research counsel (NRC) valence, arousal, and dominance (VAD) lexicon can be used to transform these categorical emotions associated with the text to the VAD space. The VAD space is a representation in affective computing to model emotions. The VAD space can map an emotion as a point in a three-dimensional space spanned by valence (V), arousal (A), and dominance (D). Valence is a measure of the pleasantness in the emotion (e.g., happy vs. sad), arousal is a measure of how active or excited the subject expressing the emotion is (e.g., angry vs. calm), and dominance is a measure of how much the subject expressing the emotion feels “in control” of their actions (e.g., proud vs. remorseful). Thus, in the example formulation, the intended emotion can be expressed as E∈{0, 1}³, where the values are coordinates in the normalized VAD space.

Attributes Depending on Agent: In further examples, attributes depending on agent to be animated can include two attributes: agent's gender G, and handedness H. In some examples, gender G∈{0, 1}² can include a one-hot representation denoting either female or male, and handedness H∈{0, 1}² can include a one-hot representation indicating whether the agent is left-hand dominant or right-hand dominant. Male and female agents typically have differences in body structures (e.g., shoulder-to-waist ratio, waist-to-hip ratio). Handedness can determine which hand dominates, especially when gesticulating with one hand (e.g., beat gestures, deictic gestures). Each agent has one assigned gender and one assigned handedness.

Using the Transformer Network: Modeling the input text and output gestures as sequences can become a sequence transduction problem. This problem can be resolved by using a transformer-based network. The transformer network can include the encoder-decoder architecture for sequence-to-sequence modeling. However, instead of using sequential chains of recurrent memory networks, or the computationally expensive convolutional networks, the example transformer uses a multi-head self-attention mechanism to model the dependencies between the elements at different temporal positions in the input and target sequences.

The attention mechanism can be represented as a sum of values from a dictionary of key-value pairs, where the weight or attention on each value is determined by the relevance or the corresponding key to a given query. Thus, given a set of m queries [symbol] ∈ [symbol] , a set of n keys K∈ [symbol] , and the corresponding set of n values V∈ [symbol] , (for some dimensions k and v), and using the scaled dot-product as a measure of relevance, Equation (2) can be expressed as:

$$Att ( Q , K , V ) = softmax ( \frac{{QK}^{T}}{k} ) V , \qquad Equation ( 2 )$$

where the softmax is used to normalize the weights. In the case of self-attention (SA) in the transformer, [symbol] , K, and V all can come from the same sequence. In the transformer encoder, the self-attention operates on the input sequence [symbol] . Since the attention mechanism does not respect the relative positions of the elements in the sequence, the transformer network can use a positional encoding scheme to signify the position of each element in the sequence, prior to using the attention. Also, in order to differentiate between the queries, keys, and values, it can project [symbol] into a common space using three independent fully-connected layers including trainable parameters [symbol] , W_{K,enc}, and W_{v,enc}. Thus, the self-attention in the encoder, SA_{enc}, can be expressed as:

$${SA}_{enc} ( 𝒲 ) = softmax ( \frac{𝒲 {W}_{Q} {W}_{K}^{T} {𝒲}_{K}^{T}}{k} ) 𝒲 {W}_{V} . \qquad Equation ( 3 )$$

The multi-head (MH) mechanism can enable the network to jointly attend to different projections for different parts in the sequence, i.e.,

MH( [symbol] )=concat(SA_{enc,1}( [symbol] ), . . . , SA_{enc,h}( [symbol] ))W_{concat}, Equation (4)

where h is the number of heads, W_{concat} is the set of trainable parameters associated with the concatenated representation, and each self-attention i in the concatenation includes its own set of trainable parameters [symbol] , W_{K,i}, and W_{V,i}.

The transformer encoder then can pass the MH output through two fully-connected (FC) layers. It can repeat the entire block comprising (SA-MH-FC) N times and uses the residuals around each layer in the blocks during backpropagation. The final encoded representation of the input sequence [symbol] can be denoted as [symbol] .

To meet the given constraints on the acting task A, intended emotion E, gender G, and/or handedness H of the virtual agent, these variables can be appended to [symbol] , and the combined representation can be passed through two fully-connected layers with trainable parameters W_{FC} to obtain feature representations

[symbol]

=FC( [symbol] A^{T}E^{T}G^{T}H^{T}]^{T};W_{FC}) Equation (5)

The transformer decoder can operate similarly using the target sequence [symbol] , but with some differences. First, it uses a masked multi-head (MMH) self-attention on the sequence, such that the attention for each element covers only those elements appearing before it in the sequence, i.e.,

MMH( [symbol] )=concat(SA_{dec,1}( [symbol] ), . . . , SA_{dec,h}( [symbol] ))W_{concat}. Equation (6)

This can ensure that the attention mechanism is causal and therefore usable at test time, when the full target sequence is not known apriori. Second, the attention mechanism can use the output of the MMH operation as the key and the value, and the encoded representation [symbol] as the query, in an additional multi-head self-attention layer without any masking, i.e.,

MH( [symbol] , [symbol] )=concat(Att_{dec,1}( [symbol] , MMH( [symbol] ), MMH( [symbol] )), . . . , Att_{dec,h}( [symbol] , MMH( [symbol] ), MMH( [symbol] )))W_{concat}. Equation (7)

The attention mechanism then can passe the output of this multi-head self-attention through two fully-connected layers to complete the block. Thus, one block of the decoder is (SA-MMH-SA-MH-FC), and the transformer network can use N such blocks. The attention mechanism can also use positional encoding of the target sequence upfront and uses the residuals around each layer in the blocks during backpropagation. In some examples, the self-attention of the decoder can work similarly to that of the encoder. However, Equation 3 for the encoder self-attention uses the input word sequence [symbol] while Equation 6 for the decoder self-attention uses the gesture sequence [symbol] . In some examples, the decoder self-attention can follow the same architecture as Equation 3 with its own set of weight vectors [symbol] , W_{K,dec}, and W_{V,dec}. The subsequent decoder operations are defined in Equations 6 and 7.

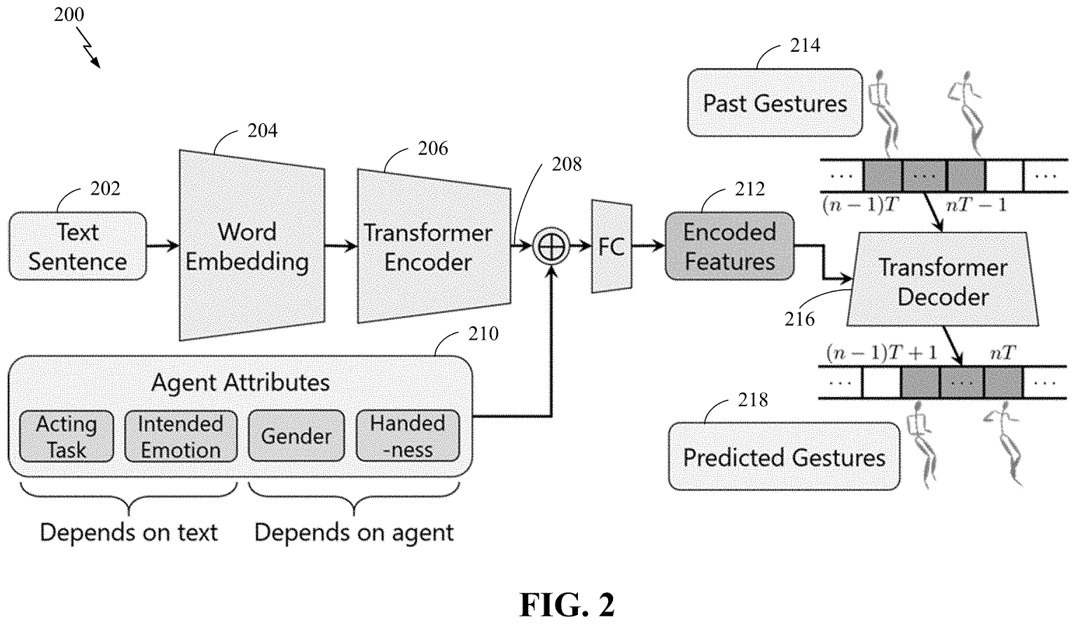

Training the Transformer-Based Network: FIG. 2 shows the overall architecture 200 of an example transformer-based network. For example, the example network can take in sentences of natural language text 202 and transform the sentences to word embeddings 204 (e.g., using the pre-trained GloVe model). The example network can then use a transformer encoder 206 to transform the word embeddings 204 to latent representations 208, append the agent attributes 210 to these latent representations 208, and transform the combined representations into encoded features 212. The transformer decoder can take in these encoded features 212 and the past gesture history 214 to predict gestures 218 for the subsequent time steps using a transformer decoder 216. At each time step, the gesture can be represented by the set of rotations on all the body joints relative to their respective parents in the pose graph at that time step.

In some examples, the word embedding layer can transform the words into feature vectors (e.g., using the pre-trained GloVe model). The encoder 206 and the decoder 216 respectively can include of N=2 blocks of (SA-MH-FC) and (SA-MMH-SA-MH-FC). h=2 heads can be used in the multi-head attention. The set of FC layers in each of the blocks can map to outputs (e.g., 200-dim outputs). At the output of the decoder 216, the predicted values can be normalized so that the predicted values represent valid rotations. In some examples, the example network can be trained using the sum of three losses: the angle loss, the pose loss, and the affective loss. These losses can be computed between the gesture sequences generated by the example network and the original motion-captured sequences available as ground-truth in the training dataset.

Angle Loss for Smooth Motions: In some examples, the ground-truth relative rotation of each joint j at time step t can be denoted as the unit quaternion q_{j,t}, and the corresponding rotation predicted by the network as \hat{q}_{j,t}. In further examples, \hat{q}_{j,t} can be corrected to have the same orientation as q_{j,t}. Then, the angle loss can be measured between each such pair of rotations as the squared difference of their Euler angle representations, modulo π. Euler angles can be used rather than the quaternions in the loss function as it can be straightforward to compute closeness between Euler angles using Euclidean distances. However, it should be appreciated that the quaternions can be used in the loss function. To ensure that the motions look smooth and natural, the squared difference between the derivatives of the ground-truth and the predicted rotations can be considered, computed at successive time steps. The net angle loss L_{ang} can be expressed as:

$${L}_{ang} = {\sum }_{t} {\sum }_{j} {( Eul ( {q}_{j , t} ) - Eul ( {\hat{q}}_{j , t} ) )}^{2} + {( Eul ( {q}_{j , t} ) - Eul ( {q}_{j , t - 1} ) - Eul ( {\hat{q}}_{j , t} ) - Eul ( {\hat{q}}_{j , t - 1} ) )}^{2} \qquad Equation ( 8 )$$

Pose Loss for Joint Trajectories: The angle loss can penalize the absolute differences between the ground-truth and the predicted joint rotations. To control the resulting poses to follow the same trajectory as the ground-truth at all time steps, the squared norm difference between the ground-truth and the predicted joint positions at all time steps can be computed. Given the relative joint rotations and the offset oⱼ of every joint j from its parent, all the joint positions can be computed using forward kinematics (FK). Thus, the pose loss Y pose can be expressed as:

Lₚₒₛₑ=ΣₜΣⱼ∥FK(q_{j,t}, oⱼ)−FK(\hat{q}_{j,t}, oⱼ)∥². Equation (9)

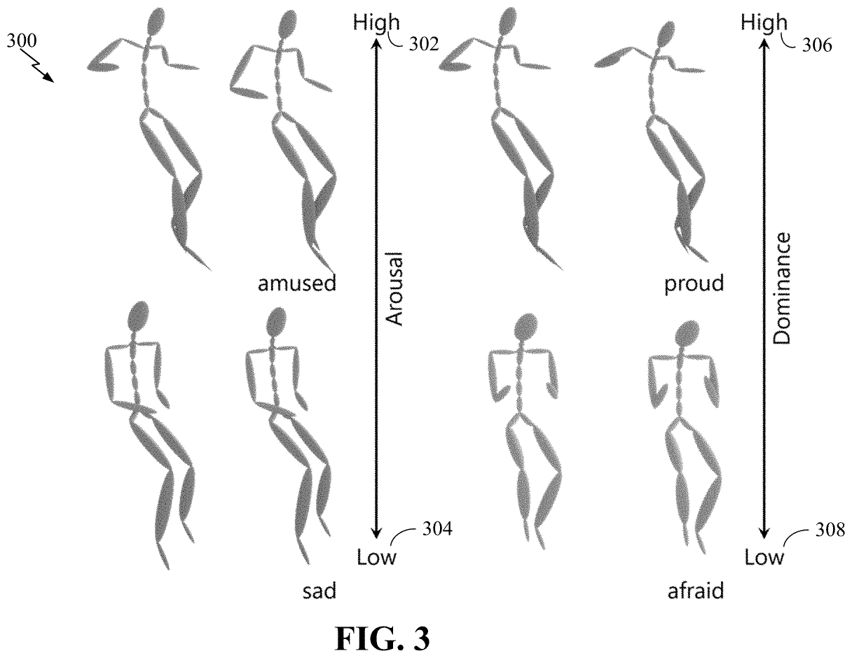

Affective Loss for Emotive Gestures: To ensure that the generated gestures are emotionally expressive, the loss between the gesture-based affective features of the ground-truth and the predicted poses can be penalized. In some examples, gesture-based affective features can be good indicators of emotions that vary in arousal and dominance. Emotions with high dominance, such as pride, anger, and joy, tend to be expressed with an expanded upper body, spread arms, and upright head positions. Conversely, emotions with low dominance, such as fear and sadness, tend to be expressed with a contracted upper body, arms close to the body, and collapsed head positions. Again, emotions with high arousal, such as anger and amusement, tend to be expressed with rapid arm swings and head movements. By contrast, emotions with low arousal, such as relief and sadness, tend to be expressed with subtle, slow movements. Different valence levels are not generally associated with consistent differences in gestures, and humans often infer from other cues and the context. FIG. 3 shows some gesture snapshots 300 to visualize the variance of these affective features for different levels of arousal and dominance. In FIG. 3, emotions with high arousal 302 (e.g., amused) generally have rapid limb movements, while emotions with low arousal 304 (e.g., sad) generally have slow and subtle limb movements. Emotions with high dominance 306 (e.g., proud) generally have an expanded upper body and spread arms, while emotions with low dominance 308 (e.g., afraid) have a contracted upper body and arms close to the body. The example algorithm can use these characteristics to generate the appropriate gestures.

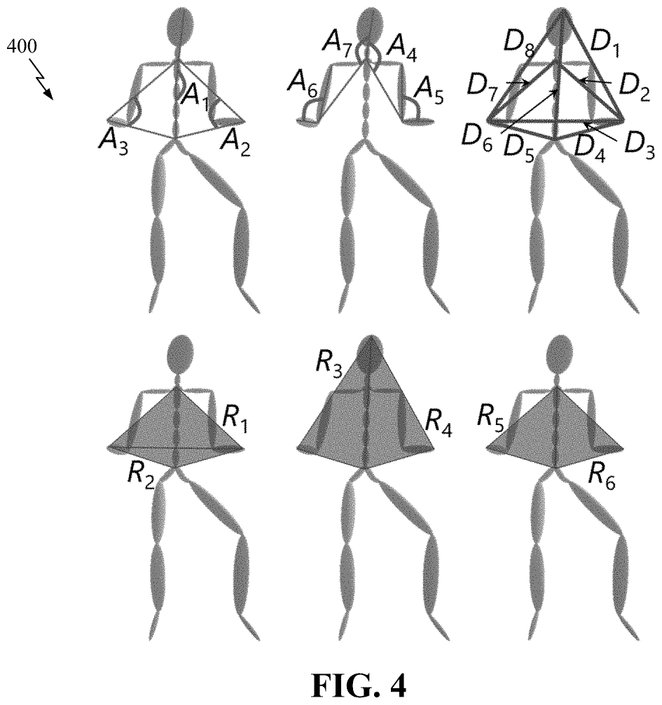

In some examples, scale-independent affective features can be defined using angles, distance ratios, and area ratios for training the example network. In some scenarios, since the virtual agent is sitting down, and the upper body can be expressive during the gesture sequences, the joints at the root, neck, head, shoulders, elbows, and wrists can move significantly. For example, the head movement of the virtual agent with/without other body movements can show emotion aligned with the text. Therefore, these joints can be used to compute the affective features. The complete list of affective features can be shown in FIG. 4. For example, a total of 15 features can be used: 7 angles: A₁ through A₇, 5 distance ratios:

$$\frac{{D}_{1}}{{D}_{4}} , \frac{{D}_{2}}{{D}_{4}} , \frac{{D}_{8}}{{D}_{5}} , \frac{{D}_{7}}{{D}_{5}} , and \frac{{D}_{3}}{{D}_{6}} ,$$

and 3 area ratios:

$$\frac{{R}_{1}}{{R}_{2}} , \frac{{R}_{3}}{{R}_{4}} , and \frac{{R}_{5}}{{R}_{6}} .$$

In some examples, the set of affective features computed from the ground-truth and the predicted poses at time t as aₜ, and âₜ respectively, the affective loss L_{aff} can be expressed as:

L_{aff}=Σₜ∥aₜ−âₜ∥². Equation (10)

Combining all the individual loss terms, the example training loss functions L can be expressed as:

L=L_{ang}+Lₚₒₛₑ+L_{aff}+λ∥W∥, Equation (11)

where W denotes the set of all trainable parameters in the full network, and i is the regularization factor.

Results: The present disclosure elaborates on the database inventors used to train, validate, and test the example method disclosed in the present disclosure. Also, the example training routine, the performance of the example method compared to the ground-truth, and the current state-of-the-art method for generating gestures aligned with text input are explained. In addition, the inventors performed ablation studies to show the benefits of each of the components in the loss function: the angle loss, the pose loss, and the affective loss.

Data for Training, Validation, and Testing: The inventors evaluated the example method on the Master Patient Index (MPI) emotional body expressions database. This database includes 1,447 motion-captured sequences of human participants performing one of three acting tasks: narrating a sentence from a story, gesticulating a scenario given as a sentence, or gesticulating while speaking a line in a conversation. Each sequence corresponds to one text sentence and the associated gestures. For each sequence, the following annotations of the intended emotion E, gender G, and handedness H, are available: 1) E as the VAD representation for one of “afraid”, “amused”, “angry”, “ashamed”, “disgusted”, “joyous”, “neutral”, “proud”, “relieved”, “sad”, or “surprised,” 2) G is either female or male, and 3) H is either left or right. Each sequence is captured at 120 fps and is between 4 and 20 seconds long. The inventors padded all the sequences with the example EOS pose described above so that all the sequences are of equal length. Since the sequences freeze at the end of the corresponding sentences, padding with the EOS pose often introduces small jumps in the joint positions and the corresponding relative rotations when any gesture sequence ends. To this end, the inventors designed the example training loss function (Equation 11) to ensure smoothness and generate gestures that transition smoothly to the EOS pose after the end of the sentence.

Training and Evaluation Routines: The inventors trained the example network using the Adam optimizer with a learning rate of 0.001 and a weight decay of 0.999 at every epoch. The inventors trained the example network for 600 epochs, using a stochastic batch size of 16 without replacement in every iteration. A total of 26,264,145 trainable parameters existed in the example network. The inventors used 80% of the data for training, validate the performance on 10% of the data, and test on the remaining 10% of the data. The total training took around 8 hours using a GPU (e.g., Nvidia® GeForce® GTX1080Ti GPU). At the time of evaluation, the inventors initialized the transformer decoder with T=20 (FIG. 2) time steps of the SOS pose and keep using the past T=20 time steps to generate the gesture at every time step.

TABLE 1
Mean pose errors. For each listed method, this is the mean Euclidean
distance of all the joints over all the time steps from all the ground-
truth sequences over the entire test set. The mean error for each sequence
is computed relative to the mean length of the longest diagonal of
the 3D bounding box of the virtual agent in that sequence.

| Method | Mean pose error |
|---|---|
| Existing method | 1.57 |
| Example method, no angle loss | 0.07 |
| Example method, no pose loss | 0.06 |
| Example method, no affective loss | 0.06 |
| Example method, all losses | 0.05 |

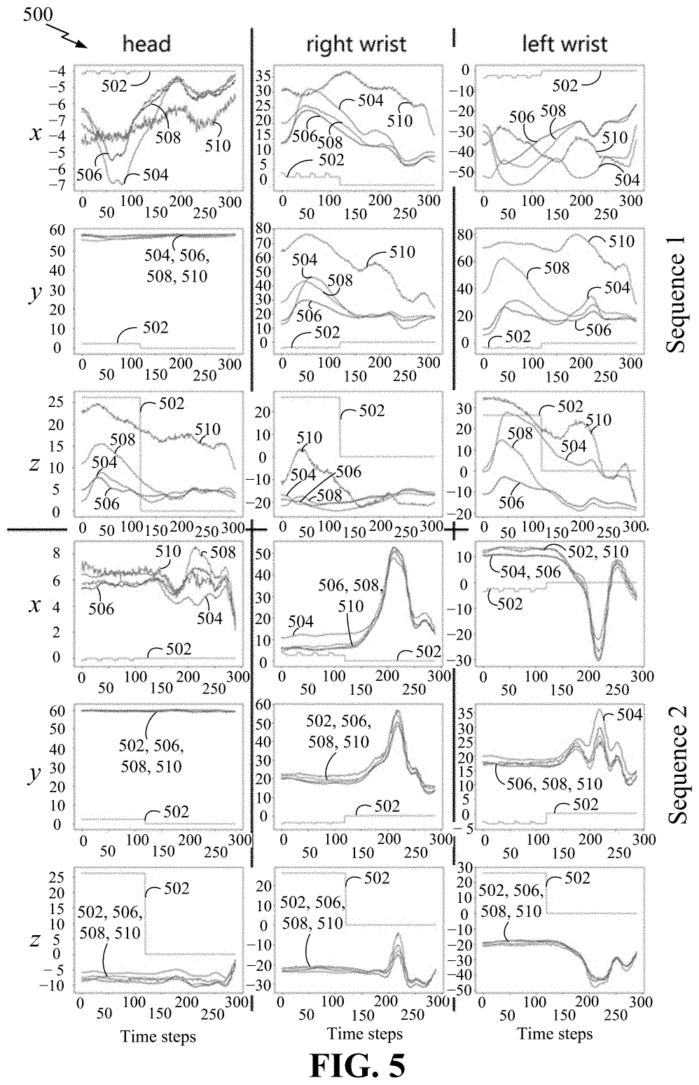

Comparative Performance: The inventors compared the performance of the example network with the transformer-based text-to-gesture generation network of an existing method. To make a fair comparison, the inventors performed the following: 1) using the eight upper body joints (three each on the two arms, neck, and head) for the existing method, 2) using principal component analysis (PCA) to reduce the eight upper body joints to 10 dimensional features, 3) retraining the existing network on the MPI emotional body expressions database, using the same data split as in the example method, and the hyperparameters used in the existing method, 4) comparing the performances only on the eight upper body joints. The mean pose error is reported from the ground-truth sequences over the entire held-out test set for both the existing method and the example method in Table 1. For each test sequence and each method, the inventors computed the total pose error for all the joints at each time step and calculate the mean of these errors across all time steps. The inventors then divided the mean error by the mean length of the longest diagonal of the 3D bounding box of the virtual agent to get the normalized mean error. To obtain the mean pose error for the entire test set, the inventors computed the mean of the normalized mean errors for all the test sequences. The inventors also plotted the trajectories of the three end-effector joints in the upper body, head, left wrist, and right wrist, independently in the three coordinate directions, for two diverse sample sequences from the test set in FIG. 5. The inventors ensured diversity in the samples by choosing a different combination of the gender, handedness, acting task, and intended emotion of the gesture for each sample.

The inventors observed from Table 1 that the example method reduces the mean pose error by around 97% over the existing method. From the plots in FIG. 5, the inventors observed that unlike the example method, the existing method is unable to generate the high amplitude oscillations in motion, leading to larger pose errors. This is because the existing method's lower dimensional representation of pose motions does not sufficiently capture the oscillations and it works with a dimension-reduced representation of the sequences. Moreover, the gestures generated by the existing method does not produce any movements in the z-axis. Instead, they confined the movements to a particular z-plane. The step in their method in the z-axis occurs when the gesture returns to the EoS rest pose, which is in a different z-plane.

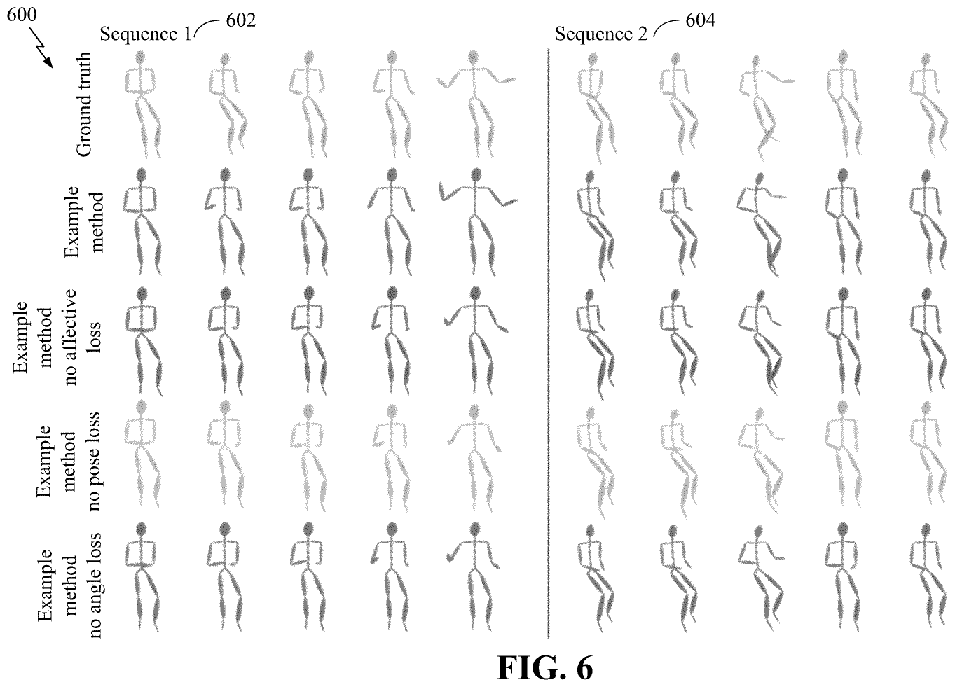

Ablation Studies: The inventors compared the performance between different ablated versions of the example method. The inventors tested the contribution of each of the three loss terms, angle loss, pose loss, and affective loss, in Equation 11 by removing them from the total loss one at a time and training the example network from scratch with the remaining losses. Each of these ablated versions has a higher mean pose error over the entire test set than the example method as shown in Table 1. FIG. 5 shows sample end-effector trajectories in the same setup above in the Comparative Performance section and visualizes the performance differences. FIG. 6 also shows snapshots from the two sample gesture sequences 602, 604 generated by all the ablated versions in FIG. 6. Snapshots of gestures at five time steps from two sample ground-truth sequences in the test set, and the gestures at the same five time steps as generated by the example method and its different ablated versions.

FIG. 5 illustrates end-effector trajectories for existing and example methods. For example, FIG. 5 shows the trajectories in the three coordinate directions for the head and two wrists. FIG. 5 also show two sample sequences from the test set, as generated by all the methods (e.g., example methods 504, methods removing the affective loss 506, methods removing the pose loss 508, and methods removing the angle loss 510). As shown in FIG. 5, the gestures become heavily jerky without the angle loss 510. When the inventors add in the angle loss but remove the pose loss 508, the gestures become smoother but still have some jerkiness. This shows that the pose loss also lends some robustness to the generation process. Removing either the angle 510 or the pose loss 508 can lead that the network can only change the gesture between time steps within some small bounds, making the overall animation sequence appear rigid and constricted. In some example, removing the pose loss 508 makes the example method unable to follow the desired trajectory. Removing the affective loss 506 reduces the variations corresponding to emotional expressiveness.

When the inventors removed only the affective loss from Equation 11, the network generated a wide range of gestures, leading to animations that appear fluid and plausible. However, the emotional expressions in the gestures, such as spreading and contracting the arms and shaking the head, might not be consistent with the intended emotions.

Interfacing the VR Environment: Given a sentence of text, the gesture animation files can be generated at an interactive rate of 3.2 ms per frame, or 312.5 frames per second, on average on a GPU (e.g., Nvidia® GeForce GTX® 1080Ti).

The inventors used gender and handedness to determine the virtual agent's physical attributes during the generation of gestures. Gender impacts the pose structure. Handedness determines the hand for onehanded or longitudinally asymmetrical gestures. To create the virtual agents, the inventors used low-poly humanoid meshes with no textures on the face. The inventors used the pre-defined set of male and female skeletons in the MPI emotional body motion database for the gesture animations.

The inventors assigned a different model to each of these skeletons, matching their genders. Any visual distortions caused by a shape mismatch between the pre-defined skeletons and the low-poly meshes was manually or automatically corrected

The inventors use Blender 2.7 to rig the generated animations to the humanoid meshes. To ensure a proper rig, the inventors modify the rest pose of the humanoid meshes to match the rest pose of the pre-defined skeletons. To make the meshes appear more life-like, the inventors add periodic blinking and breathing movements to the generated animations (e.g., using blendshapes in Blender).

The inventors prepared a sample VR environment to demonstrate certain embodiments (e.g., using Unreal 4.25). The inventors placed the virtual agents on a chair in the center of the scene in full focus. The users can interact with the agent in two ways. They can either select a story that the agent narrates line by line using appropriate body gestures or send lines of text as part of a conversation to which the agent responds using text and associated body gestures. The inventors used synthetic, neutral-toned audio aligned with all the generated gestures to understand the timing of the gestures with the text. However, the inventors did not add any facial features or emotions in the audio for the agents since they are dominant modalities of emotional expression and make a fair evaluation of the emotional expressiveness of the gestures difficult. For example, if the intended emotion is happy, and the agent has a smiling face, observers are more likely to respond favorably to any gesture with high valence or arousal. However, it should be appreciated that facial features can be added to the body gestures.

User Study: The inventors conducted a web-based user study to test two major aspects of the example method: the correlation between the intended and the perceived emotions of and from the gestures, and the quality of the animations compared to the original motion-captured sequences.

Procedure: The study included two sections and was about ten minutes long. In the first section, the inventors showed the participant six clips of virtual agents sitting on a chair and performing randomly selected gesture sequences generated by the example method, one after the other. The inventors then asked the participant to report the perceived emotion as one of multiple choices. Based on the pilot study, the inventors understood that asking participants to choose from one of 11 categorical emotions in the Emotional Body Expressions Database (EBEDB) dataset was overwhelming, especially since some of the emotion terms were close to each other in the VAD space (e.g., joyous and amused). Therefore, the inventors opted for fewer choices to make it easier for the participants and reduce the probability of having too many emotion terms with similar VAD values in the choices. For each sequence, the inventors, therefore, provided the participant with four choices for the perceived emotion. One of the choices was the intended emotion, and the remaining three were randomly selected. For each animation, randomly choosing three choices can unintentionally bias the participant's response (for instance, if the intended emotion is “sad” and the random options are “joyous”, “amused” and “proud”).

In the second section, the inventors showed the participant three clips of virtual agents sitting on a chair and performing a randomly selected original motion-captured sequence and three clips of virtual agents performing a randomly selected generated gesture sequence, one after the other. The inventors showed the participant these six sequences in random order. The inventors did not tell the participant which sequences were from the original motion-capture and which sequences were generated by the example method. The inventors asked the participant to report the naturalness of the gestures in each of these sequences on a five-point Likert scale, including the markers mentioned in Table 2.

TABLE 2
Likert scale markers to assess quality of gestures. The inventors
use the following markers in the five-point Likert scale

| | |
|---|---|
| Very Unnatural | e.g., broken arms or legs, torso at an impossible angle |
| Not Realistic | e.g., limbs going inside the body or through the chair |
| Looks OK | No serious problems, but does not look very appealing |
| Looks good | No problems and the gestures look natural |

The inventors had a total of 145 clips of generated gestures and 145 clips of the corresponding motion-captured gestures. For every participant, the inventors chose all the 12 random clips across the two sections without replacement. The inventors did not notify the participant a priori which clips had motion-captured gestures and which clips had the generated gestures. Moreover, the inventors ensured that in the second section, none of the three selected generated gestures corresponded to the three selected motion-captured gestures. Thus, all the clips each participant looked at were distinct. However, the inventors did repeat clips at random across participants to get multiple responses for each clip.

Participants: Fifty participants participated in the study, recruited via web advertisements. To study the demographic diversity, the inventors asked the participants to report their gender and age group. Based on the statistics, the inventors had 16 male and 11 female participants in the age group of 18-24, 15 male and seven female participants in the age group of 25-34, and one participant older than 35 who preferred not to disclose their gender. However, the inventors did not observe any particular pattern of responses based on the demographics.

Evaluation: The inventors analyze the correlation between the intended and the perceived emotions from the first section of the user study and the reported quality of the animations from the second section. The inventors also summarize miscellaneous user feedback.

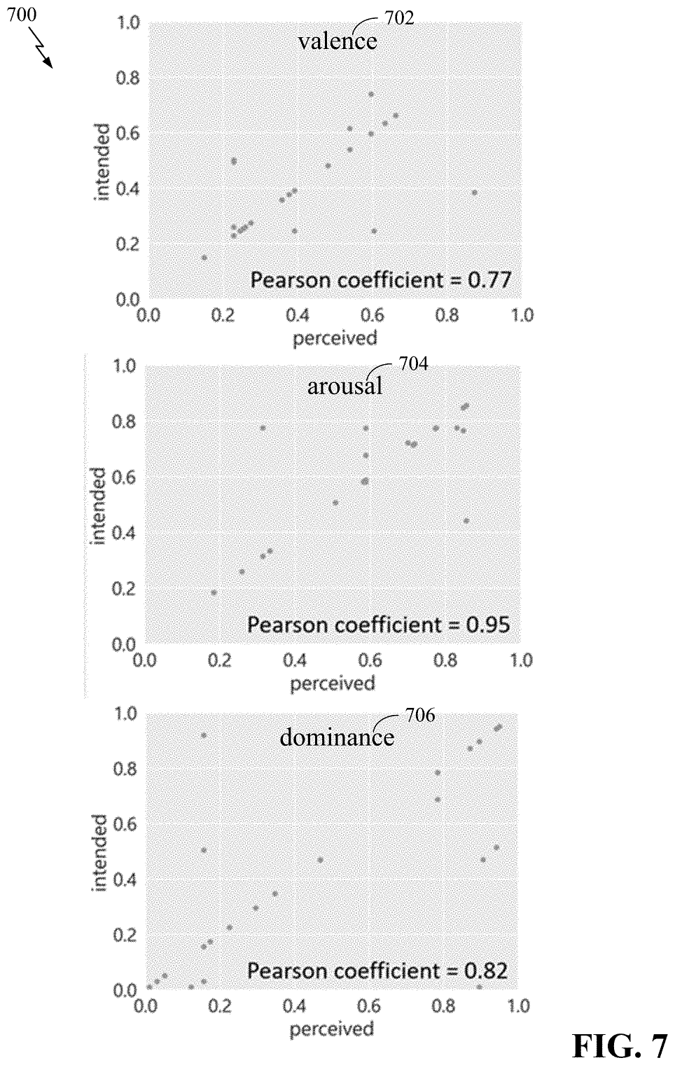

Correlation between Intended and Perceived Emotions: Each participant responded to six random sequences in the first section of the study, leading to a total of 300 responses. The inventors convert the categorical emotion terms from these responses to the VAD space using the mapping of NRC-VAD. The inventors show the distribution of the valence, arousal, and dominance values of the intended and perceived emotions in FIG. 7. FIG. 7 shows distribution of values from the intended and perceived emotions in the valence 702, arousal 704, and dominance 706 dimensions for gestures in the study. All the distributions indicate strong positive correlation between the intended and the perceived values, with the highest correlation in arousal and the lowest in valence.

The inventors compute the Pearson correlation coefficient between the intended and perceived values in each of the valence, arousal, and dominance dimensions. A Pearson coefficient of 1 indicates maximum positive linear correlation, 0 indicates no correlation, and −1 indicates maximum negative linear correlation. In practice, any coefficient larger than 0.5 indicates a strong positive linear correlation. The inventors observed that intended and the perceived values in all three dimensions have such a strong positive correlation. The inventors observed a Pearson coefficient of 0.77, 0.95, and 0.82, respectively, between the intended and the perceived values in the valence, arousal, and dominance dimensions. Thus, the values in all three dimensions are strongly positively correlated, satisfying the hypothesis. The values also indicate that the correlation is stronger in the arousal and the dominance dimensions and comparatively weaker in the valence dimension. This is in line with prior studies in affective computing, which show that humans can consistently perceive arousal and dominance from gesture-based body expressions.

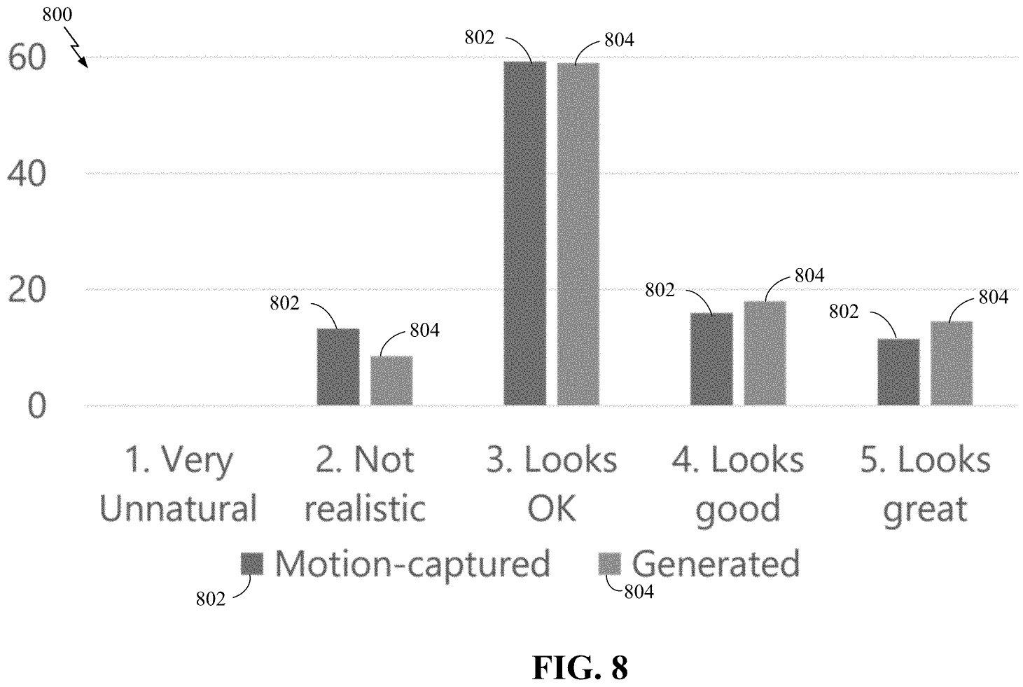

Quality of Gesture Animations: Each participant responded to three random motion-captured and three randomly generated sequences in the second section of the study. Therefore, the inventors have a total of 150 responses on both the motion-captured and the generated sequences. FIG. 8 shows the percentage of responses of each of the five points in the Likert scale and shows responses on the quality of gestures. A small fraction of participants responded to the few gesture sequences that had some stray self-collisions, and therefore found these sequences to not be realistic. The vast majority of the participants found both the motion-captured 802 and generated 804 gestures to look OK (plausible) on the virtual agents. A marginally higher percentage of participants reported that the generated gesture sequences looked better on the virtual agents that the original motion-captured gesture sequences. The inventors considered a minimum score of 3 on the Likert scale to indicate that the participant found the corresponding gesture plausible. By this criterion, the inventors observed that 86.67% of the responses indicated the virtual agents performing the motion-captured sequences have plausible gestures and 91.33% of the responses the virtual agents performing the generated sequences have plausible gestures. In some example, the inventors observed that a marginally higher percentage of responses scored the generated gestures 4 and 5 (2.00% and 3.33% respectively), compared to the percentage of responses with the same score for the motion-captured gestures. This, coupled with the fact that participants did not know apriori which sequences were motion-captured and generated, indicates that the generated sequences were perceived to be as realistic as the original motion-captured sequences. One possible explanation of participants rating the generated gestures marginally more plausible than the motion-captured gestures is that the generated poses return smoothly to a rest pose after the end of the sentence. The motion-captured gestures, on the other hand, freeze at the end-of-the-sentence pose.

Conclusion: The inventors present a novel method that takes in natural language text one sentence at a time and generates 3D pose sequences for virtual agents corresponding to emotive gestures aligned with that text. The example generative method also considers the intended acting task of narration or conversation, the intended emotion based on the text and the context, and the intended gender and handedness of the virtual agents to generate plausible gestures. The inventors can generate these gestures in a few milliseconds on a GPU (e.g., UI Nvidia® GeForce GTX® 1080Ti GPU). The inventors also conducted a web study to evaluate the naturalness and emotional expressiveness of the generated gestures. Based on the 600 total responses from 50 participants, the inventors found a strong positive correlation between the intended emotions of the virtual agents' gestures and the emotions perceived from them by the respondents, with a minimum Pearson coefficient of 0.77 in the valence dimension. Moreover, around 91% of the respondents found the generated gestures to be at least plausible on a five-point Likert Scale.

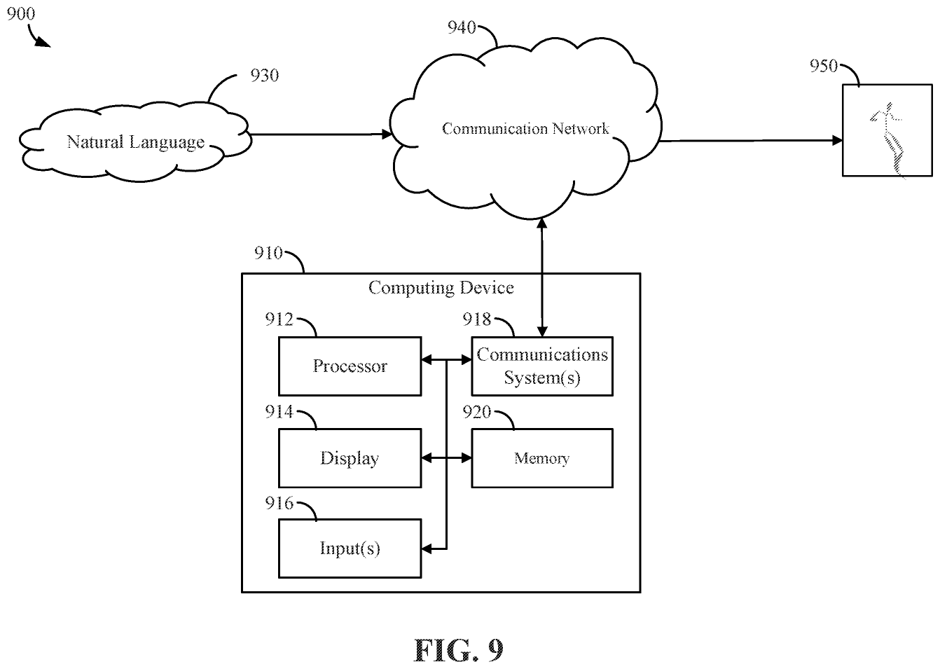

FIG. 9 shows an example 900 of a system for gesture generation in accordance with some embodiments of the disclosed subject matter. As shown in FIG. 9, a computing device 910 can receive a natural language input (e.g., text) 930. In further examples, the computing device 910 can obtain a gesture generation machine learning model and/or attribute(s). The computing device 910 processes the input (e.g., the natural language input 930 and/or attributes using the gesture generation machine learning model to produce a predicted gesture 950 of a virtual agent aligned with the natural language input.

In some examples, the computing device 910 can receive the natural language input 930, the gesture generation machine learning model, and/or attribute(s) over a communication network 940. In some examples, the communication network 940 can be any suitable communication network or combination of communication networks. For example, the communication network 940 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 940 can be a local area network, a wide area network, a public network (e.g., the Internet), a private or semi-private network (e.g., a corporate or university intranet), any other suitable type of network, or any suitable combination of networks. Communications links shown in FIG. 9 can each be any suitable communications link or combination of communications links, such as wired links, fiber optic links, Wi-Fi links, Bluetooth links, cellular links, etc. In other examples, the computing device 910 can receive the natural language input 930, the gesture generation machine learning model, and/or attribute(s) via input(s) 916 of the computing device 910. In some embodiments, the input(s) 916 can include any suitable input devices and/or sensors that can be used to receive user input, such as a keyboard, a mouse, a touchscreen, a microphone, etc.

In further examples, the computing device 910 can be any suitable computing device or combination of devices, such as a desktop computer, a laptop computer, a smartphone, a tablet computer, a wearable computer, a server computer, a computing device integrated into a vehicle (e.g., an autonomous vehicle), a robot, a virtual machine being executed by a physical computing device, etc. In some examples, the computing device 910 can train and run the gesture generation machine learning model. In other examples, the computing device 910 can only train the gesture generation machine learning model. In further examples, the computing device 910 can receive the trained gesture generation machine learning model via the communication network 410/input(s) 916 and run the gesture generation machine learning model. It should be appreciated that the training phase and the runtime phase of the gesture generation machine learning model can be separately or jointly processed in the computing device 910 (including physically separated one or more computing devices).

In further examples, the computing device 910 can include a processor 912, a display 914, one or more inputs 916, one or more communication systems 918, and/or memory 920. In some embodiments, the processor 912 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. In some embodiments, the display 914 can include any suitable display devices (e.g., a computer monitor, a touchscreen, a television, an infotainment screen, etc.) to display a sequence of gestures of the virtual agent based on an output of the gesture generation machine learning model.

In further examples, the communications system(s) 918 can include any suitable hardware, firmware, and/or software for communicating information over communication network 940 and/or any other suitable communication networks. For example, the communications system(s) 918 can include one or more transceivers, one or more communication chips and/or chip sets, etc. In a more particular example, the communications system(s) 918 can include hardware, firmware and/or software that can be used to establish a Wi-Fi connection, a Bluetooth connection, a cellular connection, an Ethernet connection, etc.

In further examples, the memory 920 can include any suitable storage device or devices that can be used to store image data, instructions, values, machine learning models, etc., that can be used, for example, by the processor 912 to perform gesture generation or training the gesture generation machine learning model, to present a sequence of gestures 950 of the virtual agent using display 914, to receive the natural language input and/or attributes via communications system(s) 918 or input(s) 916, to transmit the sequence of gestures 950 of the virtual agent to any other suitable device(s) over the communication network 940, etc. The memory 920 can include any suitable volatile memory, non-volatile memory, storage, or any suitable combination thereof. For example, memory 910 can include random access memory (RAM), read-only memory (ROM), electronically-erasable programmable read-only memory (EEPROM), one or more flash drives, one or more hard disks, one or more solid state drives, one or more optical drives, etc. In some embodiments, the memory 920 can have encoded thereon a computer program for controlling operation of computing device 910. For example, in such embodiments, the processor 912 can execute at least a portion of the computer program to perform one or more data processing and identification tasks described herein and/or to train/run the gesture generation machine learning model described herein, present the series of gestures 950 of the virtual agent to the display 914, transmit/receive information via the communications system(s) 918, etc.

Due to the ever-changing nature of computers and networks, the description of the computing device 910 depicted in the figure is intended only as a specific example. Many other configurations having more or fewer components than the computing device depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

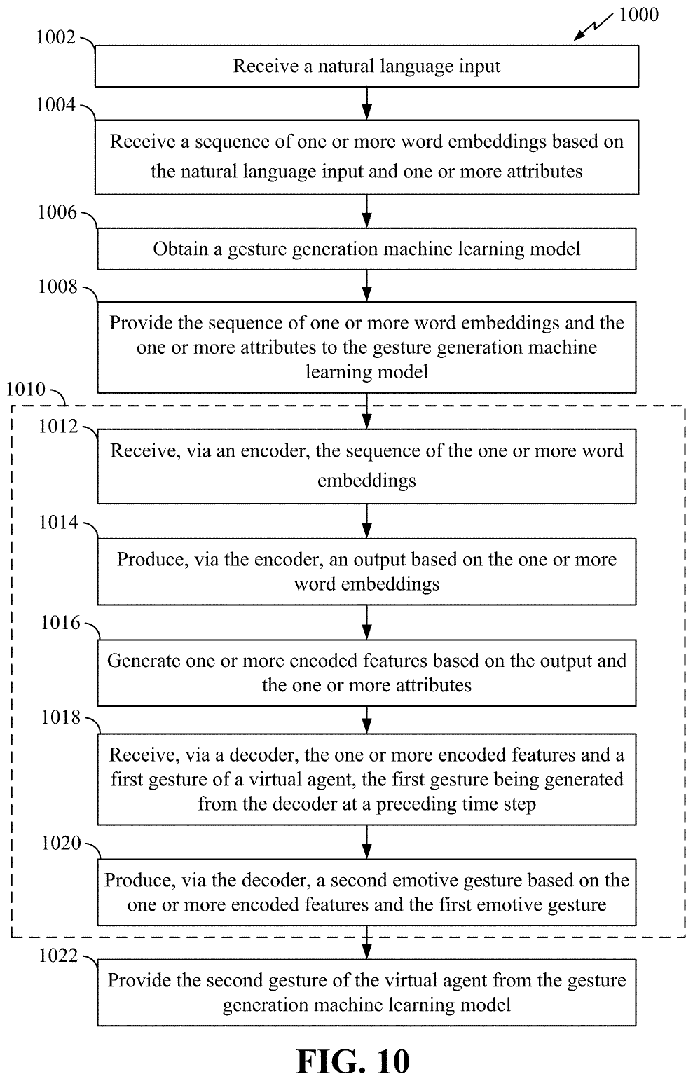

FIG. 10 is a flowchart illustrating an example method and technique for gesture generation, in accordance with various aspects of the techniques described in this disclosure. In some examples, the process 1000 may be carried out by the computing device 900 illustrated in FIG. 9, e.g., employing circuitry and/or software configured according to the block diagram illustrated in FIG. 9. In some examples, the process 1000 may be carried out by any suitable apparatus or means for carrying out the functions or algorithm described below. Additionally, although the blocks or steps of the flowchart 1000 are presented in a sequential manner, in some examples, one or more of the blocks or steps may be performed in a different order than presented, in parallel with another block or step, or bypassed.

At step 1002, process 1000 can receive a natural language input. In some examples, the natural language input can include a sentence. In further examples, the natural language input can be a text sentence (e.g., an input using a keyboard, a touch screen, a microphone, or any suitable input device, etc.). However, it should be appreciated that the natural language input is not limited to a text sentence. It can be a sentence in a speech. In further examples, the natural language input can be multiple sentences.

At step 1004, process 1000 can receive a sequence of one or more word embeddings and one or more attributes. In some examples, process 1000 can convert the natural language input to the sequence of the one or more word embeddings using a embedding model. In further examples, process 1000 can obtain the one or more word embeddings based on the natural language input using the GloVe model pre-trained on the Common Crawl corpus. However, it should be appreciated that process 1000 can use any other suitable embedding model (e.g., Word2Vec, FastText, Bidirectional Encoder Representations from Transformers (BERT), etc.).

In some examples, process 1000 can receive one or more attributes. In some examples, the one or more attributes can include an intended emotion indication corresponding to the natural language input. In further examples, the intended emotion indication can include a categorical emotion term such as joy, anger, sadness, pride, etc. In some examples, a natural language input (e.g., a sentence) can be associated with one categorical emotion. However, it should be appreciated that a natural language input (e.g., a sentence) can be associated with multiple categorical emotions. In further examples, the intended emotion indication can include a set of values in a normalized valence-arousal-dominance (VAD) space. In some examples, a user can manually enter or select an indication indicative of the intended emotion indication corresponding to the natural language input (e.g., using a keyboard, a mouse, a touch screen, a voice command, etc.). In further examples, the user can change the intended emotion indication when a corresponding sentence can be mapped to a different intended emotion indication. For example, the user selects joy for a sentence. In further examples, the intended emotion indication can include one or more letters, one or more numbers, or any other suitable symbol. For example, the intended emotion indication can be ‘:)’ to indicate joy for a sentence. If next several sentences are mapped to the same intended emotion indication (i.e., joy), the user does not change the intended emotion indication until a different sentence is mapped to a different intended emotion indication (e.g., sadness). In other examples, process 1000 can recognize the natural language input and produce an indication indicative of the intended emotion indication (e.g., using a pre-trained machine learning model). In further examples, the one or more attributes can further include an acting task. For example, the acting task can include a narration indication and a conversation indication. In some examples, the intended emotion indication and the acting task can depend on the natural language input.

In further examples, the one or more attributes can further include an agent gender indication and an agent handedness indication. In further examples, the agent gender indication can include a female indication and a male indication. In further examples, the agent gender indication can include one or more letters, one or more numbers, or any other suitable symbol. In even further examples, the agent handedness indication can include a right-hand dominant indication and a left-hand dominant indication. In further examples, the agent handedness indication can include one or more letters, one or more numbers, or any other suitable symbol. In some examples, process 1000 can determine the virtual agent based on the agent gender indication and the agent handedness indication. For example, process 1000 determine the virtual agent to be a male agent or a female agent being right-handed or left-handed based on the agent gender indication and the agent handedness indication. Thus, the agent gender indication and the agent handedness indication can depend on the natural language input. In some examples, a user can manually enter or select an acting task, an agent gender indication, and an agent handedness indication (e.g., using a keyboard, a mouse, a touch screen, a voice command, etc.). In other examples, process 1000 can determine an acting task, an agent gender indication, and an agent handedness indication (e.g., based on a user profile, a user picture, a user video, or any other suitable information).

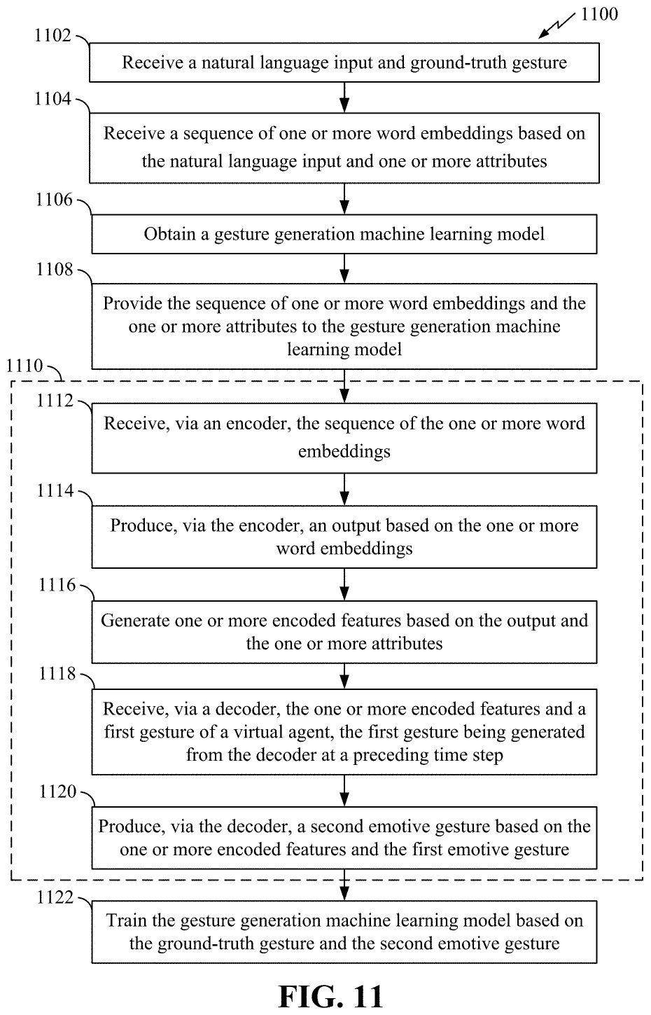

At step 1006, process 1000 can obtain a gesture generation machine learning model. In some examples, the gesture generation machine learning model can include a transformer network including an encoder and a decoder. However, it should be appreciated that the gesture generation machine learning model is not limited to a transformer network. For example, the gesture generation machine learning model can include a recurrent neural network (“RNN”), a long short-term memory (“LSTM”) model, a gated recurrent unit (“GRU”) model, a Markov process, a deep neural network (“DNN”), a convolutional neural network (“CNN”), a support vector machine (“SVM”), or any other suitable neural network model. In some examples, the gesture generation machine learning model can be trained according to process 1100 in connection with FIG. 11.

At step 1008, process 1000 can provide the sequence of one or more word embeddings and the one or more attributes to the gesture generation machine learning model. In some examples, block 1010 is the gesture generation machine learning model. Steps 1012-1020 in the block 1010 are steps in the gesture generation machine learning model. Thus, process 1000 can perform steps 1010-1020 in block 1010 using the gesture generation machine learning model.

Steps 1012 and 1014 are performed in an encoder of the gesture generation machine learning model. At step 1012, process 1000 can receive, via an encoder of the gesture generation machine learning model, the sequence of the one or more word embeddings. In some examples process 1000 can signify a position of each word embedding in the sequence of one or more word embeddings (e.g., using a positional encoding scheme). In further examples, the position can be signified prior to using an encoder self-attention component in the encoder.

In some examples, the encoder of the gesture generation machine learning model can include one or more blocks. Each bock (SA-MH-FC) can include an encoder self-attention component (SA_{enc}) configured to receive the sequence of the one or more word embeddings and produce a self-attention output, a multi-head component (MH) configured to produce a multi-head output, and a fully connected layer (FC) configured to produce the one or more latent representations. In some examples, the encoder self-attention component (SA_{enc}) is configured to project the sequence of the one or more word embeddings into a common space using a plurality of independent fully-connected layers corresponding to multiple trainable parameters. In some examples, the multiple trainable parameters are associated at least with a query (Q), a key (K), and a value (V) for the sequence of the one or more word embeddings. For example, the multiple trainable parameters can include three trainable parameters ( [symbol] , W_{K,enc}, W_{V,enc}) associated with a query (Q), a key (K), and a value (V), respectively. In some examples, the query (Q), the key (K), and the value (V) are all come from the sequence of one or more word embeddings ( [symbol] ). Thus, the encoder self-attention component (SA_{enc}) can be expressed as:

$${SA}_{enc} ( 𝒲 ) = softmax ( \frac{{𝒲W}_{Q} {W}_{K}^{T} {𝒲}^{T}}{k} ) 𝒲 {W}_{V} ,$$

where [symbol] is the sequence of one or more word embeddings, [symbol] , W_{K,enc}, W_{V,enc} are trainable parameters associated with a query (Q), a key (K), and a value (V) for the sequence ( [symbol] ), W_{K}^{T} denotes the matrix transpose of the matrix of trainable parameters W_{K} (‘X’ being Q, K, or V in the present discourse) and k is the dimensionality of the key (K).

In further examples, the multi-head component (MH) is configured to combine multiple different projections of multiple encoder self-attention components (SA_{enc,1}( [symbol] ), . . . SA_{enc,h}( [symbol] )) for the sequence of the one or more word embeddings ( [symbol] ). In further examples, each encoder self-attention component (SA_{enc,1}( [symbol] ), . . . SA_{enc,h}( [symbol] )) corresponds to the encoder self-attention component (SA_{enc}( [symbol] )) but for different projections. The multiple different projections can correspond to multiple heads (h) of the multi-head component (MH). Thus, the multi-head component (MH) can be expressed as: MH( [symbol] )=concat (SA_{enc,1}( [symbol] ), . . . , SA_{enc,h}( [symbol] ))W_{concat}, where h is the number of heads, W_{concat} is the set of trainable parameters associated with the concatenated representation, and each self-attention i in the concatenation includes its own set of trainable parameters [symbol] , W_{K,i}, and W_{V,i}.

In further examples, the fully connected layer can receive the combined plurality of different projections of the multi-head component and produce the one or more latent representations. In some examples, process 1000 can pass the output of the multi-head component (MH) in the encoder of the gesture generation machine learning model through multiple fully-connected (FC) layers (e.g., two FC layers). In some examples, process 1000 can repeat the entire block including SA-MH-FC one or more times. In further examples, process 1000 can repeat the entire block including SA-MH-FC two times and two heads in the multi-head component.

At step 1014, the gesture generation machine learning model can produce, via the encoder, an output based on the one or more word embeddings. In some examples, the encoder of the machine learning model can produce one or more latent representations based on the sequence of the one or more word embeddings.

At step 1016, the gesture generation machine learning model can generate one or more encoded features based on the output and the one or more attributes. In some examples, the gesture generation machine learning model can combine the one or more latent representations ( [symbol] ) from the encoder with the one or more attributes (i.e., the acting task A, the intended emotion indication E, the gender indication G, and/or the handedness indication H). In further example, process 1000 can transforms the combined one or more latent representations into the one or more encoded features. For example, a fully connected layer in the machine learning model can transform the combined one or more latent representations into the one or more encoded features. The fully connected layer can be multiple fully connected layers. The one or more encoded features can be obtained using this equation: [symbol] =FC([ [symbol] A^{T}E^{T}G^{T}H^{T}]^{T}; W_{FC}), where [symbol] is the one or more encoded features, FC is the fully connected layer, and W_{FC} is trainable parameters.

At step 1018, the gesture generation machine learning model can receive, via a decoder of the gesture generation machine learning model, the one or more encoded features and a first gesture of a virtual agent. In further examples, the first gesture can include a set of rotations on multiple body joints relative to one or more parent body joints.

In some examples, the decoder can generate the first emotive gesture at a preceding time step. In some examples, the decoder can include a masked multi-head (MMH) component. The MMH component can receive the first emotive gesture ( [symbol] ) and combine multiple decoder self-attention components (SA_{dec,1}( [symbol] ), . . . SA_{dec,h}( [symbol] )) for the first emotive gesture. In some examples, the MMH component can be expressed as: MMH ( [symbol] )=concat (SA_{dec,1}( [symbol] ), . . . , SA_{dec,h}( [symbol] ))W_{concat}.

In further examples, the decoder further comprises one or more blocks. In some examples, each block (SA-MMH-SA-MH-FC) can include a first self-attention component (SA_{dec}), the masked multi-head (MMH) component, a second self-attention component (SA_{dec}), a multi-head self-attention (MH) component, and a fully connected layer (FC). In some examples, the multi-head self-attention component can use the one or more encoded features as a query, the combined plurality of decoder self-attention components as a key, and the combined plurality of decoder self-attention components as a value in a self-attention operation. In some examples, MH component can be expressed as: MH ( [symbol] , [symbol] )=concat (Att_{dec,1}( [symbol] , MMH ( [symbol] ), MMH( [symbol] )), . . . Att_{dec,h}( [symbol] , MMH ( [symbol] ), MMH( [symbol] )))W_{concat}, where [symbol] is the one or more encoded features. Att_{dec,h} is a self-attention operations, and W_{concat} is the set of trainable parameters associated with the concatenated representation.

At step 1020, the gesture generation machine learning model can produce, via the decoder, a second emotive gesture based on the one or more encoded features and the first emotive gesture. In some examples, the fully connected layer of the decoder can produce the second emotive gesture. In further examples, the second gesture can include a set of rotations on multiple body joints relative to one or more parent body joints based on the first emotive gesture.

At step 1022, process 1000 can provide the second gesture of the virtual agent from the gesture generation machine learning model. In some examples, process 1000 can apply the set of rotations on multiple body joints to the virtual agent and display the movement of the virtual agent. In further examples, the second emotive gesture can include head movement of the virtual agent aligned with the natural language input. However, it should be appreciated that the second emotive gesture can include body movement, hand movement, and any other suitable movement. In further examples, the second emotive gesture can be different depending on the attributes. In some scenarios, when the acting task is indicative of narration, the second gesture can be more exaggerated and theatrical than another acting task of conversation. In further scenarios, the second gesture can be different when the intended emotion indication indicates, happy, sad, angry, calm, proud, or remorseful. In further scenarios, the second gesture can be different when the gender indication is male or female and/or when the handedness is right-handed or left-handed. Since the second gesture is produced based on the first gesture, process can produce different second gestures of the virtual agent even with the same natural language input and/or the same attributes.

FIG. 11 is a flowchart illustrating an example method and technique for gesture generation training, in accordance with various aspects of the techniques described in this disclosure. In some examples, the process 1100 may be carried out by the computing device 900 illustrated in FIG. 9, e.g., employing circuitry and/or software configured according to the block diagram illustrated in FIG. 9. In some examples, the process 1100 may be carried out by any suitable apparatus or means for carrying out the functions or algorithm described below. Additionally, although the blocks or steps of the flowchart 1100 are presented in a sequential manner, in some examples, one or more of the blocks or steps may be performed in a different order than presented, in parallel with another block or step, or bypassed.

Steps 1102-1120 are substantially the same as steps 1002-1020 in FIG. 10. However, process 1100 can further receive ground-truth gesture in step 1102.

At step 1122, process 1100 can train the gesture generation machine learning model based on the ground-truth gesture and the second emotive gesture. For example, the gesture generation machine learning model can be trained based on a loss function (L) summing an angle loss, a pose loss, and an affective loss. In some examples, a ground-truth gesture can include ground-truth relative rotation of a joint, and the second emotive gesture comprises a predicted relative rotation of the joint. In further examples, the loss function L can be defined as L=L_{ang}+Lₚₒₛₑ+L_{aff}+λ∥W∥, where W denotes the set of all trainable parameters in the full network, and i is the regularization factor.

In some examples, the angle loss can be defined as: L_{ang}=ΣₜΣⱼ(Eul(q_{j,t})−Eul(\hat{q}_{j,t}))²+(Eul(q_{j,t-1})−Eul(\hat{q}_{j,t})−Eul (\hat{q}_{j,t-1}))², where L_{ang} is the angle loss, t is a time for the second emotive gesture, j is a plurality of joints including the joint, q_{j,t} is the ground-truth relative rotation of a respective joint j at a respective time t,\hat{q}_{j,t} is the predicted relative rotation of the respective joint j at the respective time t.

In further examples, the pose loss can be defined as: Lₚₒₛₑ=ΣₜΣⱼ∥FK(q_{j,t},oⱼ)−FK(\hat{q}_{j,t},oⱼ)∥², where Lₚₒₛₑ is the angle loss, t is a time for the second emotive gesture, j is a plurality of joints including the joint, q_{j,t} is the ground-truth relative rotation of a respective joint j at a respective time t, \hat{q}_{j,t} is the predicted relative rotation of the respective joint j at the respective time t, oⱼ is an offset of the relative joint j, FK( )is a forward kinematics.

In further examples, process 1100 can calculate multiple ground-truth affective features based on the ground-truth gesture and calculate multiple pose affective features based on the second emotive gesture. In further examples, the affective loss can be defined as L_{aff}=Σₜ∥aₜ−âₜ∥², where L_{aff} is the affective loss, t is a time for the second emotive gesture, aₜ is the plurality of ground-truth affective features, and âₜ is the plurality of pose affective features.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the general nature of the technical disclosure, but is in no way intended for defining, determining, or limiting the scope of the present disclosure or any of its embodiments.

What is claimed is:

1. A method for gesture generation, comprising:
receiving a sequence of one or more word embeddings and one or more attributes;
obtaining a gesture generation machine learning model;
providing the sequence of one or more word embeddings and the one or more attributes to the gesture generation machine learning model, the gesture generation machine learning model configured to:
receive, via an encoder, the sequence of the one or more word embeddings;
produce, via the encoder, an output based on the one or more word embeddings;
generate one or more encoded features based on the output and the one or more attributes;
receive, via a decoder, the one or more encoded features and a first emotive gesture of a virtual agent, the first emotive gesture being generated from the decoder at a preceding time step; and
produce, via the decoder, a second emotive gesture based on the one or more encoded features and the first emotive gesture; and
providing the second emotive gesture of the virtual agent from the gesture generation machine learning model.

2. The method of claim 1, further comprising:
receiving a natural language input, and
converting the natural language input to the sequence of the one or more word embeddings using a embedding model.

3. The method of claim 2, further generating three-dimensional pose sequences based on the second emotive gesture for the virtual agent corresponding to emotive gestures aligned with the natural language text input.

4. The method of claim 2, wherein the natural language input comprises: a sentence.

5. The method of claim 2, wherein the one or more attributes comprise: an intended emotion indication corresponding to the natural language input.

6. The method of claim 5, wherein the intended emotion indication comprises a set of values in a normalized valence-arousal-dominance (VAD) space.

7. The method of claim 1, wherein the one or more attributes comprise: an acting task, an agent gender indication, and an agent handedness indication.

8. The method of claim 7, further comprising:
determining the virtual agent based on the agent gender indication and the agent handedness indication.

9. The method of claim 1, wherein the encoder of the machine learning model produces one or more latent representations based on the sequence of the one or more word embeddings,
wherein the machine learning model combines the one or more latent representations with the one or more attributes, and
wherein the machine learning model transforms the combined one or more latent representations into the one or more encoded features.

10. The method of claim 9, wherein a fully connected layer in the machine learning model transforms the combined one or more latent representations into the one or more encoded features.

11. The method of claim 9, further comprising:
signifying a position of each word embedding in the sequence of one or more word embeddings.

12. The method of claim 9, wherein the encoder comprises one or more blocks, each bock comprising an encoder self-attention component configured to receive the sequence of the one or more word embeddings and produce a self-attention output, a multi-head component configured to produce a multi-head output, and a fully connected layer configured to produce the one or more latent representations,
wherein the encoder self-attention component is configured to project the sequence of the one or more word embeddings into a common space using a plurality of independent fully-connected layers corresponding to a plurality of trainable parameters, the plurality of trainable parameters associated at least with a query, a key, and a value for the sequence of the one or more word embeddings,
wherein the multi-head component is configured to combine a plurality of different projections of a plurality of encoder self-attention components for the sequence of the one or more word embeddings, each encoder self-attention component corresponding to the encoder self-attention component, the plurality of different projections corresponding to a plurality of heads of the multi-head component,
wherein the fully connected layer is configured to receive the combined plurality of different projections of the multi-head component and produce the one or more latent representations.

13. The method of claim 1, wherein the decoder comprises a masked multi-head component, the masked multi-head component configured to receive the first emotive gesture and combine a plurality of decoder self-attention components for the first emotive gesture.

14. The method of claim 13, wherein the decoder comprises one or more blocks, each block comprising: a first self-attention component, the masked multi-head component, a second self-attention component, a multi-head self-attention component, and a fully connected layer,
wherein the multi-head self-attention component is configured to use the one or more encoded features as a query, the combined plurality of decoder self-attention components as a key, and the combined plurality of decoder self-attention components as a value in a self-attention operation,
wherein the fully connected layer is configured to produce the second emotive gesture.

15. The method of claim 1, wherein the second emotive gesture comprises a set of rotations on multiple body joints relative to one or more parent body joints based on the first emotive gesture.

16. The method of claim 1, wherein the second emotive gesture comprises head movement of the virtual agent.

17. A method for gesture generation training, comprising:
receiving ground-truth gesture;
a sequence of one or more word embeddings and one or more attributes;
providing the sequence of one or more word embeddings and the one or more attributes to a gesture generation machine learning model, the gesture generation machine learning model configured to:
receive, via an encoder, the sequence of the one or more word embeddings;
produce, via the encoder, an output based on the one or more word embeddings;
generate one or more encoded features based on the output and the one or more attributes;
receive, via a decoder, the one or more encoded features and a first emotive gesture of a virtual agent, the first emotive gesture being generated from the decoder at a preceding time step; and
produce, via the decoder, a second emotive gesture based on the one or more encoded features and the first emotive gesture; and
training the gesture generation machine learning model based on the ground-truth gesture and the second emotive gesture.

18. The method of claim 17, wherein the gesture generation machine learning model is trained based on a loss function summing an angle loss, a pose loss, and an affective loss.

19. The method of claim 18, wherein a ground-truth gesture comprises ground-truth relative rotation of a joint,
wherein the second emotive gesture comprises a predicted relative rotation of the joint.

20. The method of claim 19, the angle loss is defined as:
L_{ang}=ΣₜΣⱼ(Eul(q_{j,t})−Eul(\hat{q}_{j,t}))²+(Eul(q_{j,t})−Eul(q_{j,t-})−Eul(\hat{q}_{j,t})−Eul(\hat{q}_{j,t-1}))², where L_{ang} is the angle loss, t is a time for the second emotive gesture, j is a plurality of joints including the joint, q_{j,t} is the ground-truth relative rotation of a respective joint j at a respective time t, \hat{q}_{j,t} is the predicted relative rotation of the respective joint j at the respective time t.

21. The method of claim 19, wherein the pose loss is defined as:
Lₚₒₛₑ=ΣₜΣⱼ∥FK(q_{j,t}, oⱼ)−FK(\hat{q}_{j,t}, oⱼ)∥², where Lₚₒₛₑ is the angle loss, t is a time for the second emotive gesture, j is a plurality of joints including the joint, q_{j,t} is the ground-truth relative rotation of a respective joint j at a respective time t, \hat{q}_{j,t} is the predicted relative rotation of the respective joint j at the respective time t, oⱼ is an offset of the relative joint j, FK( )is a forward kinematics.

22. The method of claim 19, further comprising:
calculating a plurality of ground-truth affective features based on the ground-truth gesture; and
calculating a plurality of pose affective features based on the second emotive gesture,
wherein the affective loss is defined as:
L_{aff}=Σₜ∥aₜ−âₜ∥², where L_{aff} is the affective loss, t is a time for the second emotive gesture, aₜ is the plurality of ground-truth affective features, and âₜ is the plurality of pose affective features.

23. A system for gesture generation, comprising:
a processor;
a memory having stored thereon a set of instructions which, when executed by the processor, cause the processor to:
receive a sequence of one or more word embeddings and one or more attributes;
obtain a gesture generation machine learning model;
provide the sequence of one or more word embeddings and the one or more attributes to the gesture generation machine learning model, the gesture generation machine learning model configured to:
receive, via an encoder, the sequence of the one or more word embeddings;
produce, via the encoder, an output based on the one or more word embeddings;
generate one or more encoded features based on the output and the one or more attributes;
receive, via a decoder, the one or more encoded features and a first emotive gesture of a virtual agent, the first emotive gesture being generated from the decoder at a preceding time step; and
produce, via the decoder, a second emotive gesture based on the one or more encoded features and the first emotive gesture; and
provide the second emotive gesture of the virtual agent from the gesture generation machine learning model.
